(19) United States
(12) Patent Application Publication
(10) Pub. No.: US 2005/0108179 A1
(43) Pub. Date: May 19, 2005

(54) Support method, program and support apparatus for transition between portable telephone companies

(75) Inventor: Atsumasa Mizuno, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/823,605

(22) Filed: Apr. 14, 2004

(30) Foreign Application Priority Data
Nov. 6, 2003 (JP) 2003-376528

(51) Int. Cl. H04K 1/00

(52) U.S. Cl. 705/80

(57) ABSTRACT

A transition request reception unit receives a request for transition between portable telephone companies from a customer terminal, and a customer determination unit determines whether the customer is qualified or not. If it is determined that the customer is qualified, an after-transition service information presentation unit presents information about an after-transition service equivalent to a service contracted before transition and about the contract to the customer terminal. A service contract unit receives contract information for the after-transition service from the customer terminal to conclude the contract and notifies the customer terminal of the result.

### BACKGROUND OF THE INVENTION

1. Field of the Invention

The present invention relates generally to a support method, program and support apparatus for transition between portable telephone companies in number porting which switches the portable telephone company retaining the same telephone number and, more particularly, to a support method, program and support apparatus for transition between portable telephone companies strongly supporting transition of various services already contracted other than primary communication service.

2. Description of the Related Arts

Traditionally, telephone numbers of portable telephone terminals are handled as possessions, and therefore, number porting, in which transition to another communication carrier is performed without changing the telephone number, is impossible. However, recently, due to increasing competition of portable telephone services, needs for introducing the number portability system in which the communication cattier can be easily switched without changing the telephone number have been increased, and since in each country in Europe and United States and others, similar system is already introduced, and domestically, studies for the introduction at government level are implemented, the introduction will be achieved at some future time.

However, if number porting, in which a user can use the same telephone number as before in the case of switching a communication cattier, is achieved, the user must conclude a contract for ending utilization with a communication cattier before transition and a contract for utilization with a communication cattier after transition, and for various services to which the user subscribed before transition, must contract again with each service company after transition and must notify the communication carrier after transition of a payment financial institution for the utilization fee, taking time and effort in its own way. Therefore, it is contemplated that communication carriers build support systems with computers for easily achieving the number porting by users. But, since the number porting by users has no merit for the communication carrier before transition, it seems unlikely that the carrier will actively support the burden of the user, and there is no other choice than building a service basically shouldered by users. For the communication carrier after transition, there is merit of new subscriptions due to the transition, but for various services other than the telephone number, processes will be easier and more reliable by making these services handled as new contracts rather than making services before transition continued. Therefore, if the number porting by users is achieved as a system, it is not necessarily expected that the support system is established from the user's standpoint as long as depending on the communication carriers. As a result, despite presence of many users who want to transit to another portable telephone company for the reason that, for example, the fee and others become cheaper, in fact, it is expected to continue using the portable telephone company currently contracted, avoiding efforts to search various after-transition services equivalent to the services contracted before transition and concluded a contract again, and in order to eliminate this, it is desirable to build a system in which transition of services associated with the number porting can be performed smoothly.

### SUMMARY OF THE INVENTION

According to the present invention there is provided a computer-based support method, program and support apparatus for transition between portable telephone companies, which are built by a service operating organization independent from the communication carriers and which enable the user's service environment before transition to be continued after transition.

The present invention provides a support method for transition between portable telephone companies using a computer. The support system of the present invention comprises a transition request reception step which receives a request for transition between portable telephone companies from a customer terminal; a determination step which determines whether a customer is qualified or not; an after-transition service information presentation step which, if it is determined that the customer is qualified, presents information about an after-transition service equivalent to a service contracted before transition and about the contract to the customer terminal; and a service contract step which receives contract information for the after-transition service from the customer terminal to conclude the contract, the service contract step notifying the customer terminal of the result. In this case, the service contract step includes, after conclusion of the contract, sending a program for performing environment setting of the contracted services to a portable telephone terminal of the customer. The determination step includes, if it is determined that the customer is qualified, notifying a computer in an after-transition portable telephone company of the result of the determination to start the service. The after-transition service information presentation step includes, if a service before transition is available continuously, presenting information on a continuing contract with a service company, the after-transition service information presentation step including, if the service before transition is unavailable continuously, presenting information on a new contract with another service company equivalent thereto. The support method for transition between portable telephone companies of the present invention takes the form that the support computer (support server) intervenes between the user terminal and the computer of the communication carrier to perform support processes, but the process with the user terminal may be performed via the computer of the communication carrier. In other words, the interactions with the customer terminal in the transition request reception step, the determination step, the after-transition service information presentation step and the service contract step may be performed such that the computer of the portable telephone company which is the destination of transition exits in between.

The present invention provides a program for the support of transition between portable telephone companies. The program is operable to cause a computer supporting transition between portable telephone companies to execute a transition request reception step which receives a request for transition between the portable telephone companies from a customer terminal; a determination step which determines whether a customer is qualified or not; an after-transition service information presentation step which, if it is determined that the customer is qualified, presents information about an after-transition service equivalent to a service contracted before transition and about the contract to the customer terminal; and a service contract step which receives contract information for the after-transition service from the customer terminal to conclude the contract, the service contract step notifying the customer terminal of the result.

The present invention provides a support apparatus for transition between portable telephone companies. The support apparatus comprises a transition request reception unit which receives a request for transition between portable telephone companies from a customer terminal; a determination unit which determines whether a customer is qualified or not; an after-transition service information presentation unit which, if it is determined that the customer is qualified, presents information about an after-transition service equivalent to a service contracted before transition and about the contract to the customer terminal; and a service contract unit which receives contract information for the after-transition service from the customer terminal to conclude the contract, the service contract unit notifying the customer terminal of the result.

According to the present invention, in the case that a request for transition between portable telephone companies is received from a user terminal, if it is determined that the transition is available, by searching and presenting the services equivalent to the various services contracted before the transition to a user to be able to be selected, it is possible to reduce a burden of the user due to the contract termination, continuation or new contract associated with transition of the various services, and the transition of the various services can be performed smoothly in connection with the transition of the portable telephone terminal, and therefore, the transition between the portable telephone companies through the number porting can be activated. Since support processes for the transition between the portable telephone companies accompanied by the number porting are provided by an operating organization independent from the portable telephone companies, it is possible to provide the support service from the user's standpoint without being influenced by interests of the portable telephone companies, to assure equal competition opportunity for the portable telephone companies and to promote activation of the portable telephone market associated with the introduction of the number portability system.

The above and other objects, features and advantages of the present invention will become more apparent from the following detailed description with reference to the drawings.

### BRIEF DESCRIPTION OF THE DRAWINGS

FIG. 1 is an explanatory diagram of a support system for transition between portable telephone companies according to the present invention;

FIG. 2 is an explanatory diagram of hardware environment of a computer used for the support server of FIG. 1;

FIG. 3 is an explanatory diagram of the customer management file of FIG. 1;

FIG. 4 is an explanatory diagram of the service map file of FIG. 1;

FIGS. 5A and 5B are time charts showing a support process in transition between portable telephone companies of the present invention;

FIG. 6 is an explanatory diagram of a series of operation screens for number porting utilizing a regular portable telephone terminal;

FIG. 7 is an explanatory diagram of a series of operation screens for number porting using a portable telephone terminal corresponding to the present invention;

FIG. 8 is a flowchart of a customer terminal process for performing number porting;

FIG. 9 is a flowchart of an after-transition portable telephone company process to number porting from a customer terminal;

FIG. 10 is a flowchart of a support server process according to the present invention;

FIG. 11 is a flowchart of a service transition information edit process performed in the support server process of FIG. 10;

FIGS. 12A and 12B are time charts of a support process of an embodiment in which the support server directly interacts with the customer terminal;

FIG. 13 is a flowchart of a support server process of FIGS. 12A and 12B; and

FIG. 14 is a flowchart of an after-transition portable telephone company process of FIG. 13.

### DESCRIPTION OF THE PREFERRED EMBODIMENTS

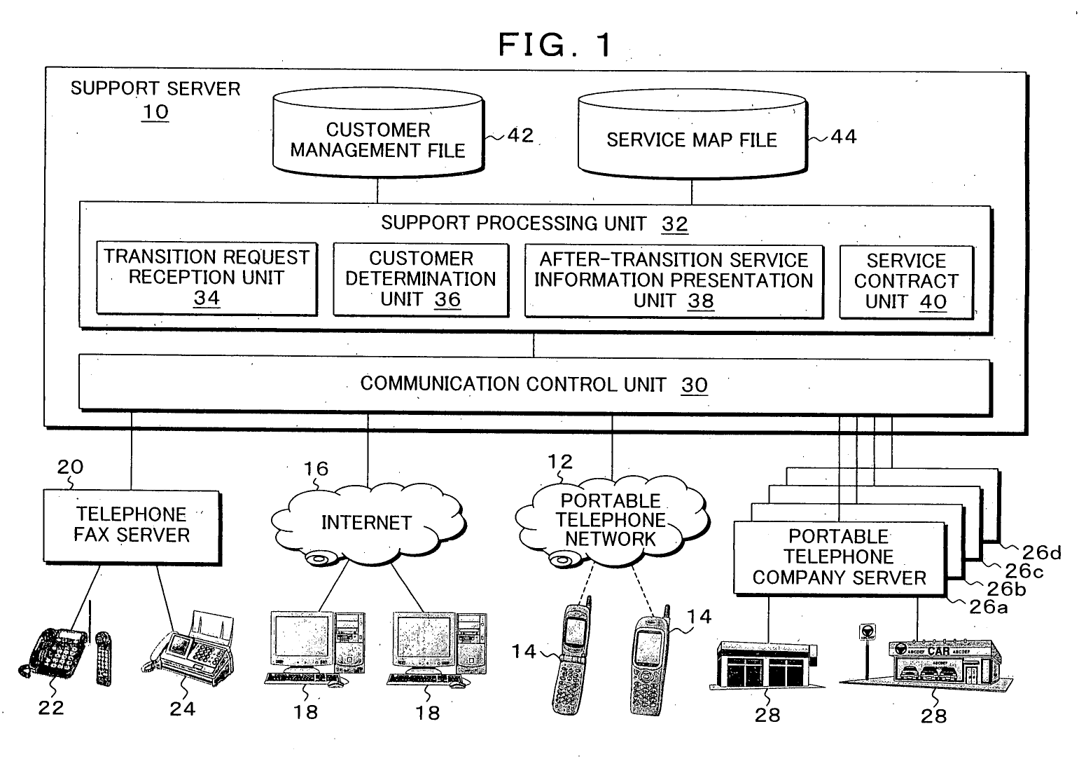

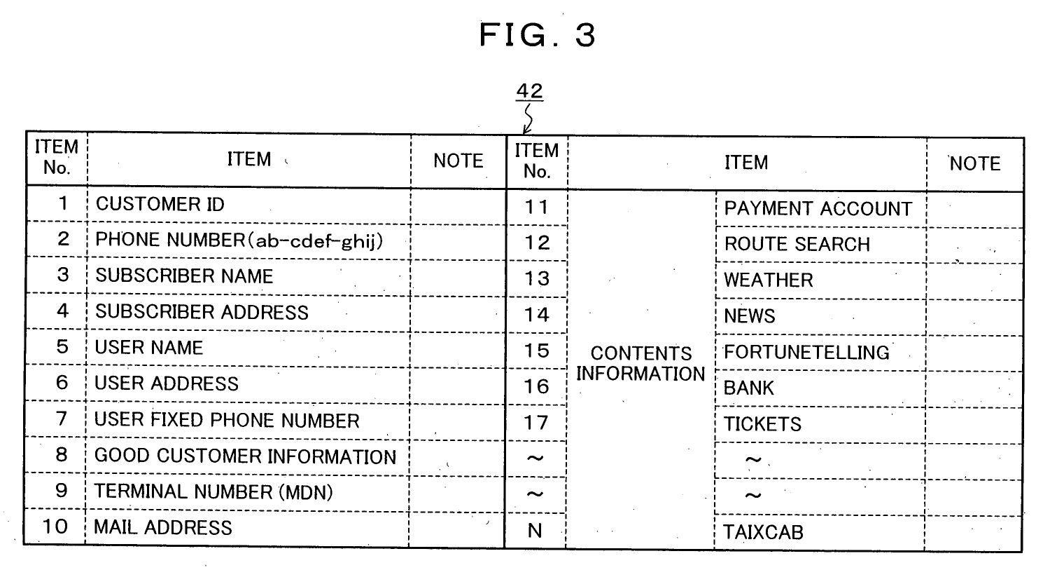

FIG. 1 is an explanatory diagram of a support system for transition between portable telephone companies, associated with number porting, according to the present invention. In FIG. 1, the support process of transition between portable telephone companies according to the present invention is provided by a support server 10. It is desirable that the support server 10 is managed by any operating organization independent from a plurality of the portable telephone companies (communication carriers), and the support process will be operated from the neutral position to both users, or customers, and the portable telephone companies. To the support server 10, portable telephone terminals 14 are connected via portable telephone network; customer personal computer terminals 18 are connected via the internet 16; a fixed telephone 22 and a facsimile 24 are connected via a telephone fax server 20; and the support process associated with the number porting can be requested to the support server by the use of any of these customer terminals. To the support server 10, portable telephone company servers 26a to 26d are also connected, and as represented and shown by the portable telephone company servers 26a, terminals of distributors 28 are connected. The support server 10 is provided with a communication control unit 30 and a support processing unit 32. The communication control unit 30 performs communication control for exchanging information between various customer terminals and the portable telephone company server 26a, 26b. The support processing unit 32 is achieved by functions of application programs for the support process and provided with each function of a transition request reception unit 34, a customer determination unit 36, an after-transition service information presentation unit 38 and a service contract unit 40. To this support processing unit 32, a customer management file 42 and a service map file 44 are respectively connected as databases. The transition request reception unit 34 provided in the support processing unit 32 receives a request for transition between portable telephone companies from the customer terminal. This request for transition between portable telephone companies is a transition request associated with the number porting. This transition request associated with the number porting from the customer terminal is sent to the support server 10 and also sent to the after-transition portable telephone company server at the same time. The transition request from the user terminal to the portable telephone company server may be sent directly, or via the support server. When the request for transition between portable telephone companies associated with the number portal is received, the customer determination unit 36 searches the customer management file 42 and determines whether it is good customer or not. The standard of whether it is good customer or not is, for example, absence of delinquency in payment of the utilization fee as a general rule and, in addition, that the customer exceeds a certain level defined by the frequency of utilization and others. If the customer determination unit 36 determines that the customer is qualified as a transition customer due to the number porting, or as the good customer, the after-transition service information presentation unit 38 presents information on the after-transition services equivalent to the services contracted before transition and contracts thereof to the requesting customer terminal. The service contract unit 40 receives contract information for the after-transition services based on the information presented by the after-transition service information presentation unit 38 from the customer terminal, concludes contracts and notifies the after-transition portable telephone company server, for example, the portable telephone company server 26a, of results thereof. After concluding the contracts with service companies based on the information for the after-transition services from the terminal customer, the service contract unit 40 also sends a program for setting environment of the contracted services to the portable telephone terminal 14 of the customer who enters into the contracts. Therefore, on the customer side, at the time of the operation for starting the service from the after-transition portable telephone company, for example, the activating operation by inputting the code number notified by the after-transition portable telephone company, the environment setting program for the contracted services, which is sent from the support server 10 to be loaded, is activated, and it is possible to automatically perform the environmental setting necessary for the contracted services which are contracted after transition. If the before-transition service can be utilized continuously after transition, the after-transition service information presentation unit 38 also presents information on the continuing contract with the service company, and if the before-transition service can not be utilized after transition, it will present information on equivalent service companies and new contracts to the side of the customer terminal. The support server 10 of FIG. 1 is achieved by hardware resources of a computer such as shown in FIG. 3, for example.

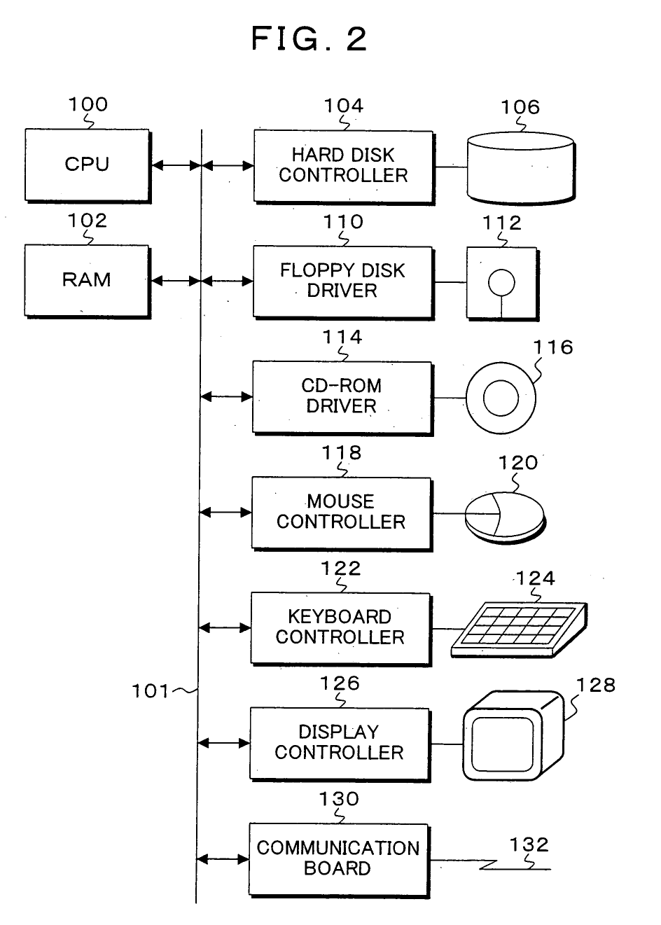

In the computer of FIG. 2, a bus 101 of CPU 100 is connected with RAM 102, a hard disk controller (software) 104, a floppy disk driver (software) 110, a CD-ROM driver (software) 114, a mouse controller 118, a keyboard controller 122, a display controller 126 and a communication board 130. The hard disk controller 104 is connected with a hard disk drive 106 and loaded with application programs which execute the support processes for transition between portable telephone companies associated with the number porting request, and calls a necessary program from the hard disk drive 106 at startup of the computer, deploys the program on RAM 102 and executes it with CPU 100. The floppy disk driver 110 is connected with a floppy disk drive (hardware) 112 and can read from and write to a floppy disk (R). The CD-ROM driver 114 is connected with a CD drive (hardware) 116 and can read data and programs stored in CD. The mouse controller 118 transfers input operations of a mouse 120 to CPU 100. The keyboard controller 122 transfers input operations of a keyboard 124 to CPU 100. The display controller 126 performs the display on a display unit 128. The communication board 130 uses a communication line 232 including wireless to communicate with other apparatuses on the internet.

FIG. 3 is an explanatory diagram of the customer management file 42 provided in the support server of FIG. 1 and shows a file for one (1) person as an example. In the customer file of FIG. 3, item numbers 1 to 10 are the attribute information of the customer, and a customer ID, a phone number, a subscriber name, a subscriber address, a user name, a user address, a user fixed phone number, a good customer information, a terminal number and a mail address are registered. Following these, item numbers 11 to n are the contents information of the services other than the communication service utilized by the customer, and it is possible to register, for example, payment account, route search, weather, news, fortunetelling, bank, tickets, . . . , taxi and others. The portable telephone company servers 26a to 26d is also provided with a similar customer management file as a database.

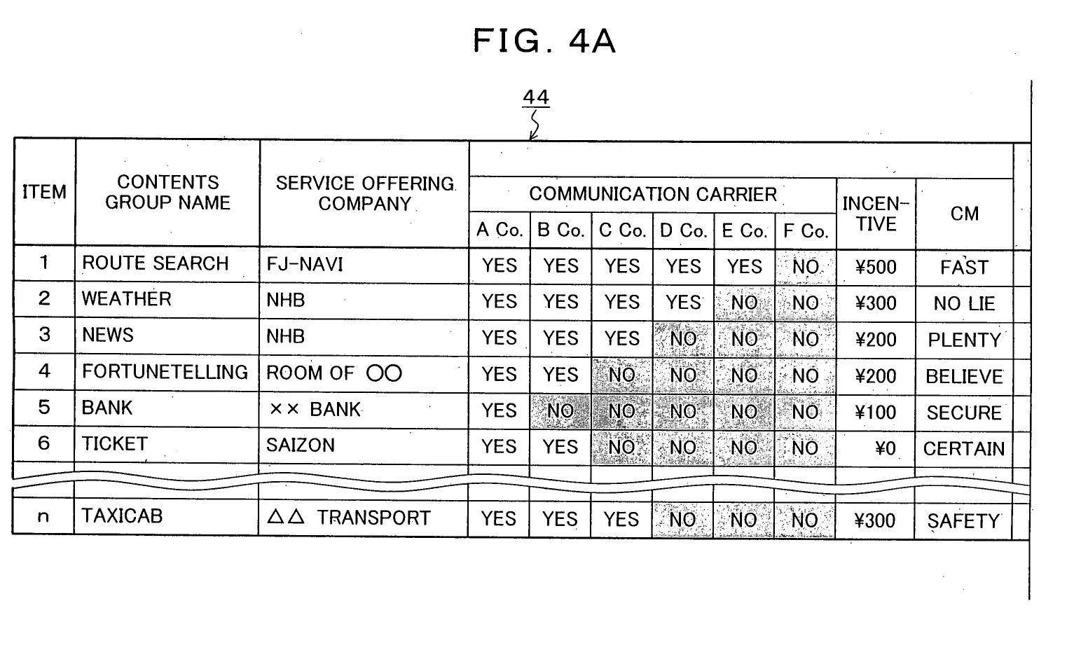

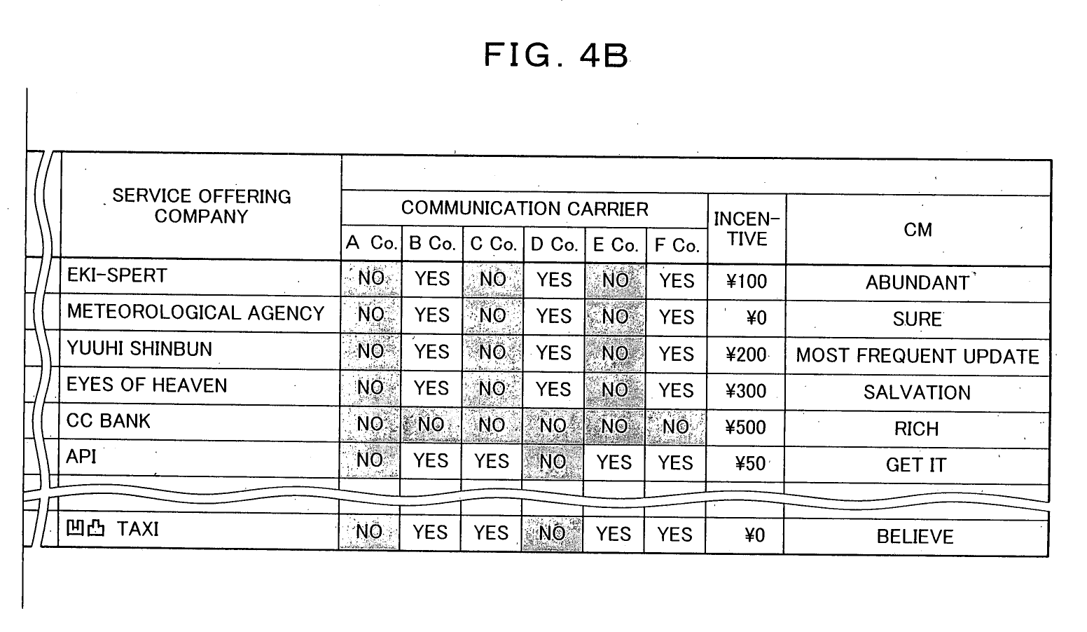

FIG. 4 is an explanatory diagram of the service map file 44 provided in the support server 10. In the service map file 44, for item numbers 1 to n, route search, weather, news, fortunetelling, bank, ticket, and taxi are registered in this example. For each contents group name, a service provider and communication carriers, or telephone companies, in which the service is available, as well as an incentive and a commercial message are provided. For example, taking the contents name “route search” as an example, “FJ-navi” and “EKI-spert” are present as the service companies in this example, and for six (6) companies of A co., B co., C co., D co., E co. and F co., which are present as the communication carrier, “YES” is registered if the service can be provided, and “NO” is registered if the service is not supported. Therefore, if the after-transition portable telephone company, or communication carrier, associated with the number porting can be identified, it is possible to know whether the service before the transition can be continued or not, and if it can not be continued, the contents group (service) available after the transition can be obtained.

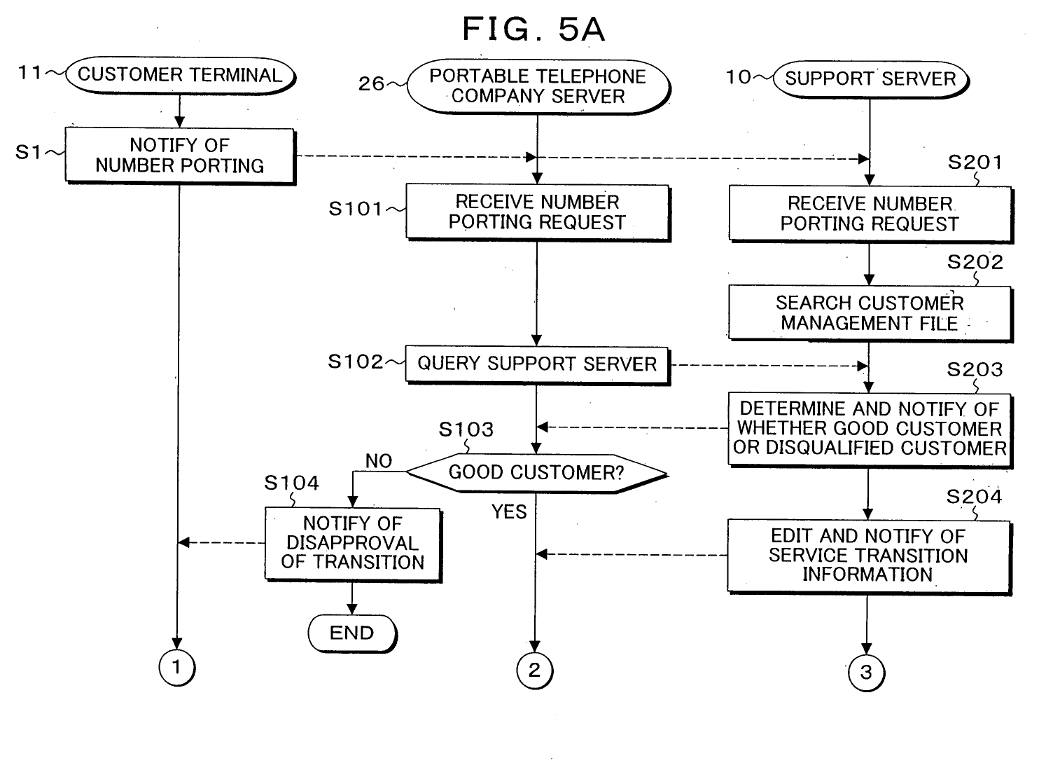

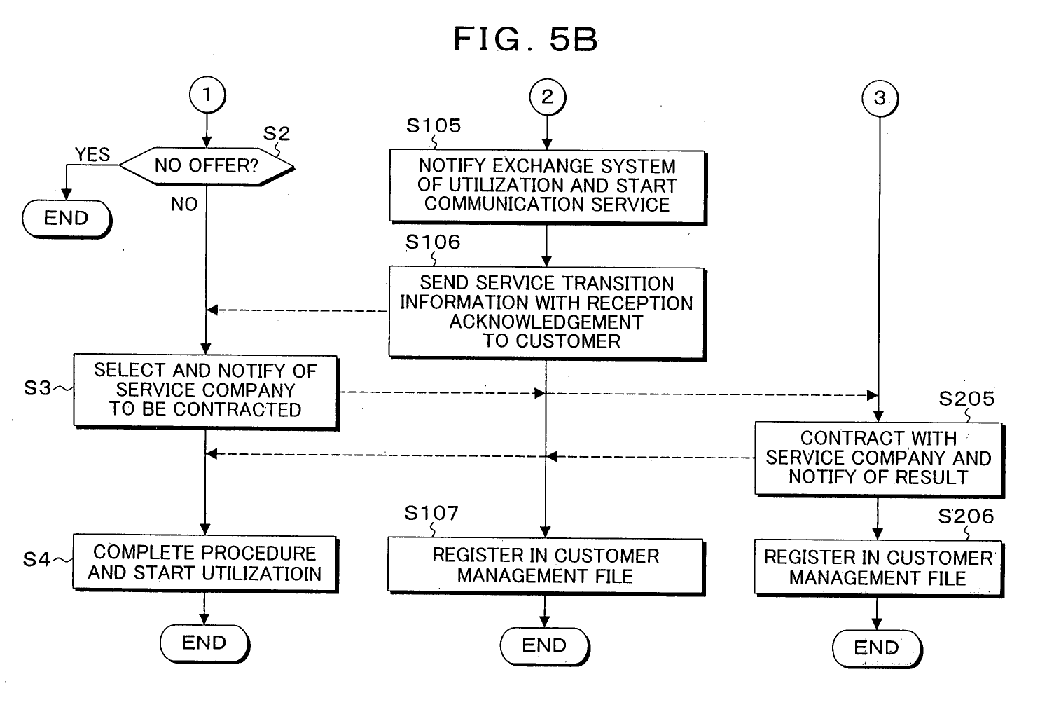

FIGS. 5A and 5B are time charts showing a support process for a customer terminal 11 as the portable telephone terminal 14 of the support server 10 of FIG. 1 and the after-transition portable telephone company server 26 associated with the number porting, according to the present invention. First, the customer terminal 11 notifies of the number porting (transition request) in step S1. In this example, the notification of the number porting is performed respectively for the after-transition portable telephone company server 26 and the support server 10 provided according to the present invention. When receiving the number porting request from the customer terminal 11 in step S101, the portable telephone company server 26 queries the support server 10 whether the requesting customer is a good customer or not. On the other hand, when the support server 10 receives the number porting request from the customer terminal 11 in step S201, it searches the customer management file 42 such as shown in FIG. 3 and reads the good customer information thereof in step S202. Subsequently, in response to the query from the portable telephone company server 26, it determines and notifies whether a good customer or a disqualified customer in step S203. In step S103, the portable telephone company server 26 determines whether a good customer or not based on the notification from the support server 10, and if the customer is not a good customer, it proceeds to step S104 to notify the customer terminal 11 of disapproval of the transition. If the customer is a good customer, it proceeds to step S105 to notify the company's exchange system of utilization and start the communication service. On the other hand, at this stage, the support server 10 edits service transition information including information on after-transition services equivalent to before-transition services and the contracts thereof by searching the service map file 44 such as shown in FIG. 4 and performs notification in step S204. Therefore, in step S106, the portable telephone company server 26 sends the service transition information received from the support server 10 to the customer terminal 11, along with a reception acknowledgement to the customer terminal 11. The customer terminal 11 selects and notifies of the service company with which the user contracts after viewing the service transition information received from the portable telephone company server 26 in step 3. This selection of the contract service company includes selection for the continuing contract and selection for the new contract. The notification based on the service companies to be contracted from the customer terminal 11 is sent to the support server 10 via the portable telephone company server 26, and in response to this, the support server 10 concludes contracts with the selected service companies and notifies the portable telephone company server 26 and the customer terminal 11 of the results in step S205 as well as registers in the customer management file 42 in step S206. The portable telephone company server 26 registers results of contracts with the service companies in the customer management file. Since a series of processes of transition between portable telephone companies associated with the number porting is completed, the customer terminal 11 terminates the process in response to the display of completion of the procedure and start of utilization in step S4.

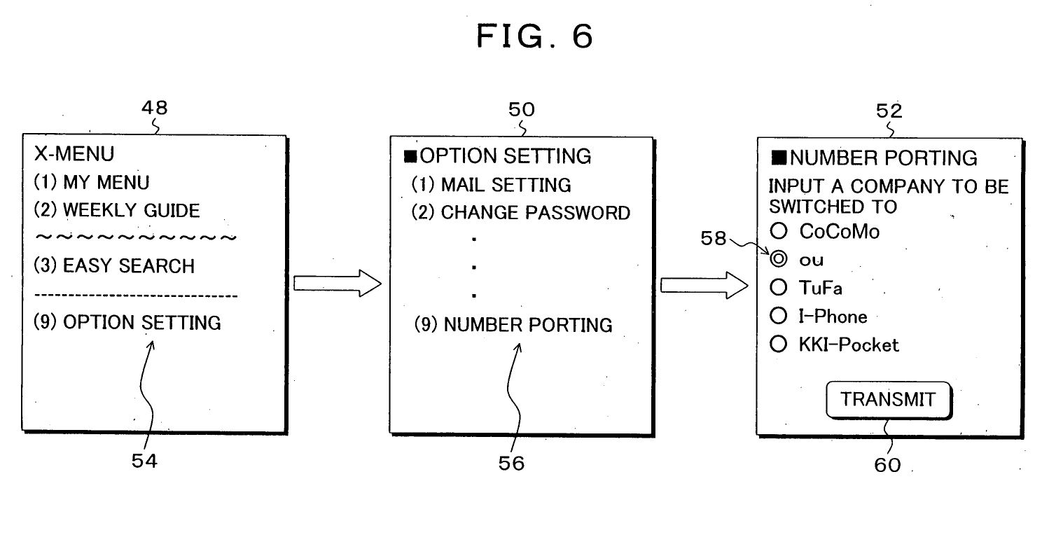

FIG. 6 is an explanatory diagram of a series of operation screens working with the support process of the present invention in the number porting utilizing a regular portable terminal. In FIG. 6, first, an operation screen 48 is opened, and “option setting” shown as an item 54 is selected from this, for example. Since an option setting screen 50 is opened by this, “number porting” which is an item 56 is selected from the menu. In this way, a number porting screen 52 is opened, and names of companies after switching are indicated along with radio buttons in the screen. By selecting “ou” as the company after switching as shown by the radio button 58 and pushing a transmit button 60, the notification of the number porting in step S1 in the customer terminal 11 of FIGS. 5A and 5B will be performed to the after-transition portable telephone server 26 and the support server 10. For the processes of step S2 to S4 in the customer terminal 11 of FIGS. 5A and 5B in the case that these regular portable telephones are used, since there is no application corresponding to the support process of the present invention, interactions with the customer terminal 11 utilizing a mail function will be performed, for example.

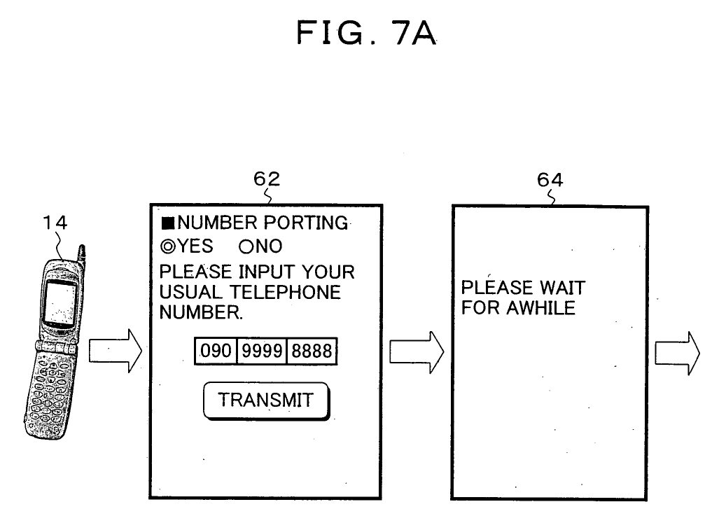

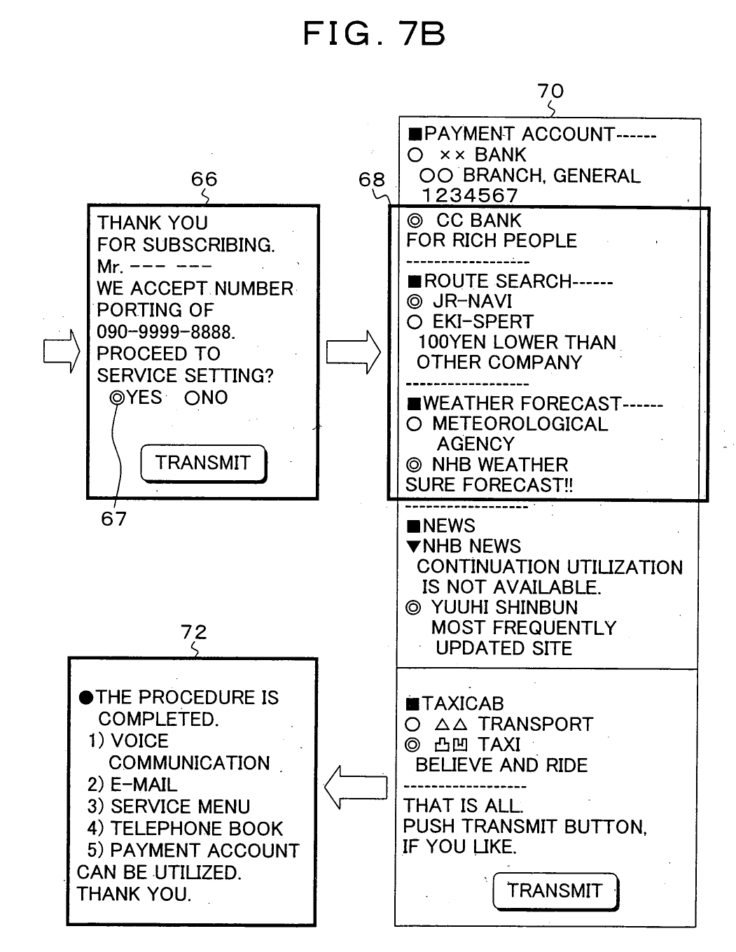

FIG. 7 is an explanatory diagram of a series of operation screens in the number porting using a portable telephone terminal which has the application corresponding to the support process of the present invention. In FIG. 7, when the application for the number porting is opened in the portable telephone terminal 14 corresponding to the present invention, an operation screen 62 is opened as a default screen, and after selecting the request of the number porting by a radio button 63, telephone number before transition is input, and a transmission button is pushed. Subsequently, the screen is switched to a stand-by screen 64, and if the support server 10 determines that the user is a good customer, an operation screen 66 is displayed, and completion of the reception of the number porting is notified. Since execution of service setting can be enabled or not, a radio button 67 is operated, and the transmission button is pushed. Based on this, an edit process of after-transition service information is performed in the support server 10, and after-transition service information 70 is created to be sent to the portable telephone terminal 14. For this after-transition service information 70, the scrolling display is performed on an operation screen 68, and therefore, the user determines services desired while opening the contents group names which are types of services in sequence. As the after-transition service information, there are two (2) types, which are:
(1) continuing service; and
(2) new services due to unavailability of continuation.
   Therefore, as the after-transition service information, in the case that the service can be continued, the service company is displayed, and simultaneously, services which have merits for the customer is additionally displayed. In this way, the customer can not only continue using the same service, but also select the service which is equivalent but has further merit. After a series of selection for the after-transition service information on the operation screen 68 is completed, by pushing the transmission button, contract information for the selected service company is sent to the support server 10, and after the contract process is conducted, an operation screen 72 is displayed concurrently with completion of the contract. On the operation screen 72, contents of the contracted services are displayed, and a series of processes associated with the number porting is terminated with this.

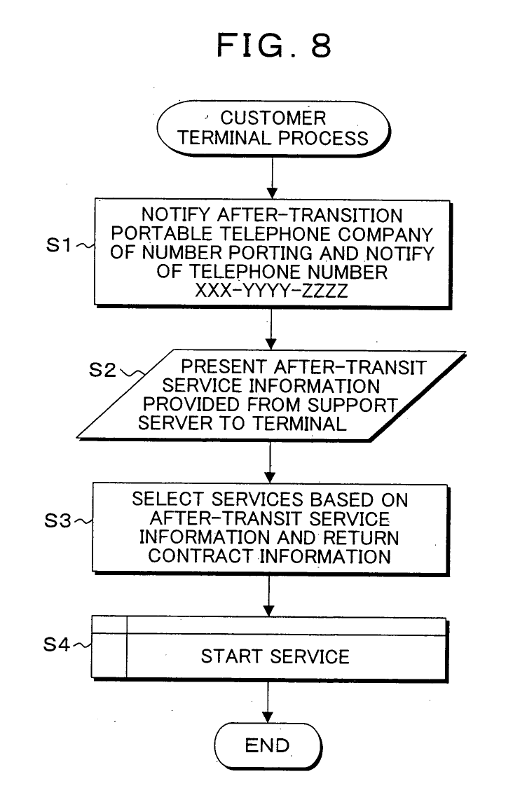

FIG. 8 is a flowchart of the portable terminal process executing the process of transition between portable telephone companies associated with the number porting of FIGS. 5A and 5B, which consists of following process procedures.

Step S1: The number porting is notified to the after-transition portable telephone company, and a telephone number “XXXX-YYYY-ZZZZ” is notified.

Step S2: After-transition service information provided from the support server 10 is presented to the terminal.

Step S3: Services are select based on the after-transition service information, and the contract information is returned.

Step S4: After receiving results of the contracts, the services are started.

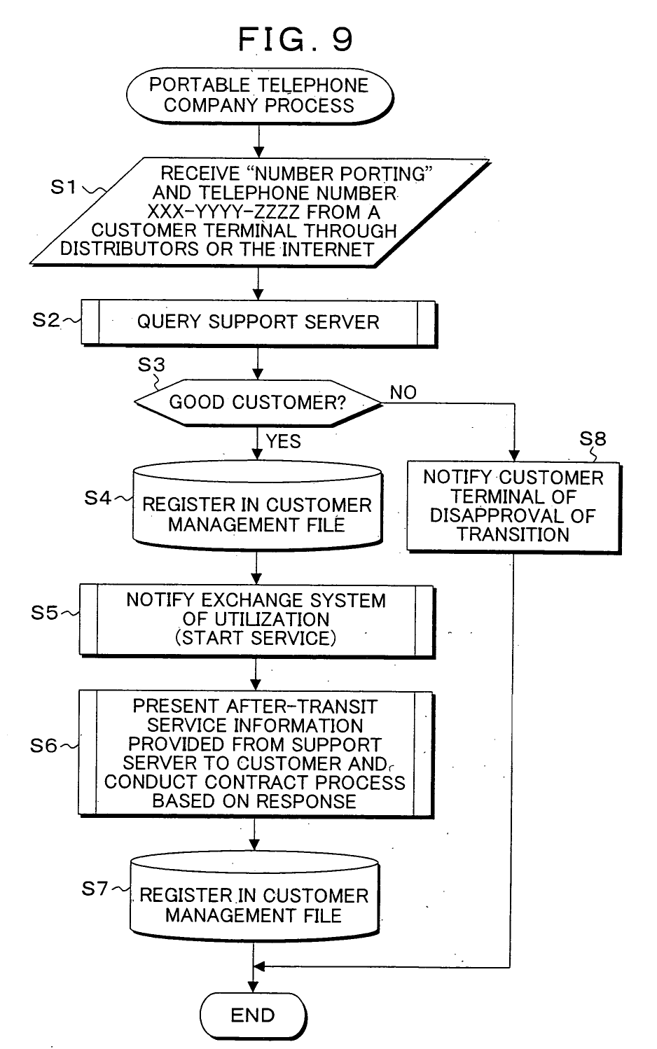

FIG. 9 is a flowchart showing the process procedures of the after-transition portable telephone company server to the number porting from the customer terminal 11 of FIGS. 5A and 5B, which is as follows.

Step S1: A request of the number porting and a telephone number “XXXX-YYYY-ZZZZ” is received from the customer terminal through distributors, the internet or others.

Step S2: The support server is queried whether it is a good customer or not.

Step S3: If it is a good customer, the procedure proceeds to Step S4, and if it is not a good customer, the procedure proceeds to Step S8.

Step S4: Since it is a good customer, registration in the customer management file is performed for accepting the number porting.

Step S5: the company's exchange system is notified of utilization by the use of the telephone number of the accepted number porting, and the communication service is started.

Step S6: The after-transition service information from the support server is presented to the customer terminal, and the results of the contracts are received, which is based on the notification of the contract information to the support server 10 in conformity with the selection of the services from the customer terminal which views this service information.

Step S7: In a customer management system, information of the services for which the contracts are concluded is registered in the customer management file.

Step S8: This is the case that it is not a good customer in step S3, and disapproval of transition is notified to the customer terminal, and the process is terminated.

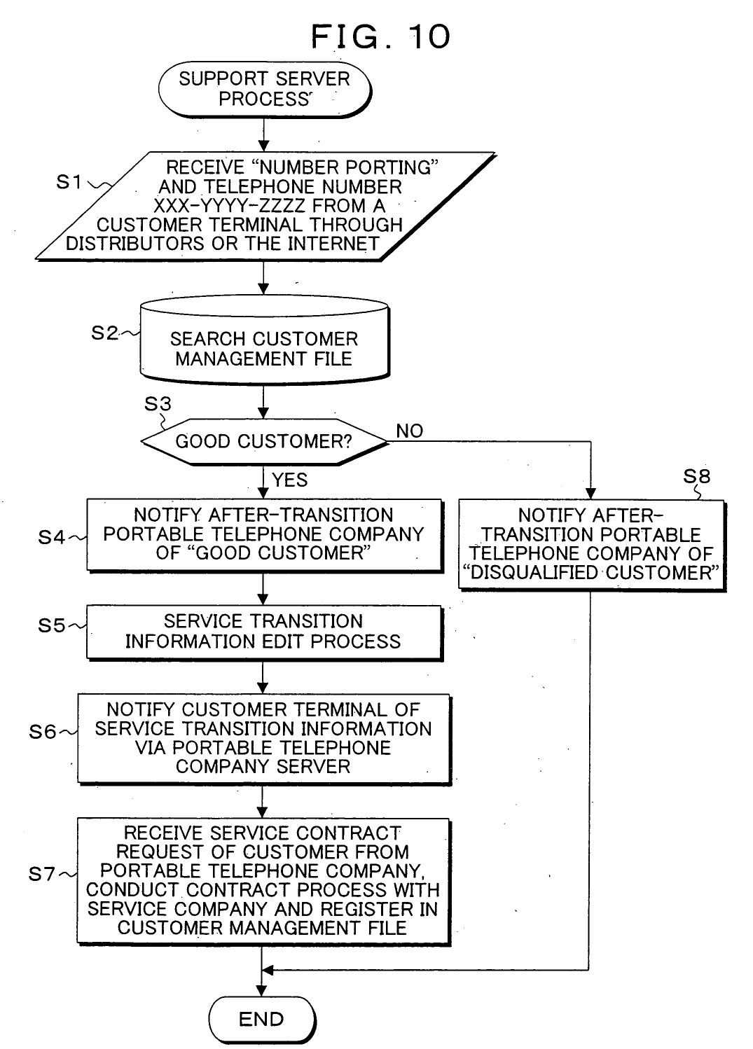

FIG. 10 is a flowchart showing process procedures of the support server 10 of the invention which executes the process of FIGS. 5A and 5B, which is as follows.

Step S1: A request of the number porting and a telephone number “XXXX-YYYY-ZZZZ” is received from the customer terminal through distributors or the internet.

Step S2: The customer management file 42 is searched.

Step S3: If determined from the search result of the customer management file 42 that it is a good customer, the procedure proceeds to Step S4, and if it is not a good customer, the procedure proceeds to Step S8.

Step S4: The after-transition portable telephone company is notified that it is a good customer.

Step S5: A service transition information edit process is executed, in which, for the customer who performs the number porting request received in step S1, the information on the after-transition services equivalent to the services contracted before transition and the contracts thereof is edited.

Step S6: The service transition information is notified to the customer terminal via the portable telephone company server.

Step S7: A service contract request sent from the customer terminal is received via the portable telephone company server, and after contract processes with the service companies are performed, the results are notified to the portable telephone company server and the customer terminal and registered in the customer management file 42, and the process is terminated.

Step S8: This is the case that it is not a good customer in step S3, and the after-transition portable telephone company server is notified that it is a disqualified customer to terminate a series of processes.

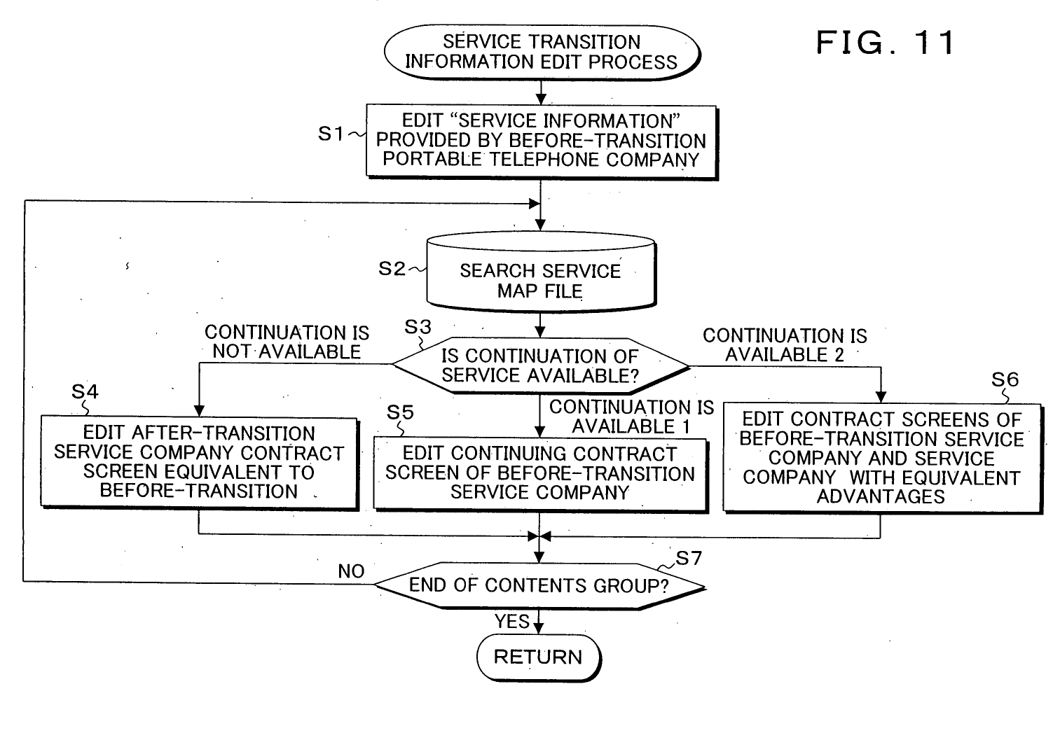

FIG. 11 is a flowchart showing details of the service transition information edit process in step S5 of FIG. 10, which consists of following process procedures.

Step S1: Service information is edit. in the before-transition portable telephone company.

Step S2: The service map file 44 is searched to obtain information of services which can be provided by the after-transition portable telephone company.

Step S3: Whether the service can be continued or not is checked. If it can not be continued, the procedure proceeds to step S4. If it can be continued, the procedure proceeds to step S5 or step S6. At this point, available continuation 1 is the available continuation when the same service company as before transition is used. On the other hand, available continuation 2 is the case of available continuation when the information of equivalent services which have merits for the customer is added along with the before-transition service information.

Step S4: This is the case that the continuation of the service is not available, and a contract screen of the service companies which provide services equivalent to the before-transition services is edited.

Step S5: This is the case that the continuation of the service is available, and a continuing contract screen of the before-transition service company is edited.

Step S6: This is the case that not only the continuation of the service is available, but also equivalent services which have merits for the customer exist, and for example, a contract screen of the service company during promotion period and a contract screen of the continuing service company are edited.

Step S7: After any edit process of step S4, S5 and S6 is completed, whether there is an edit process or not is checked for all the contents groups, and if it is not completed, the procedure goes back to step S2, and if it is completed, the process is terminated to return to the main routine of FIG. 10.

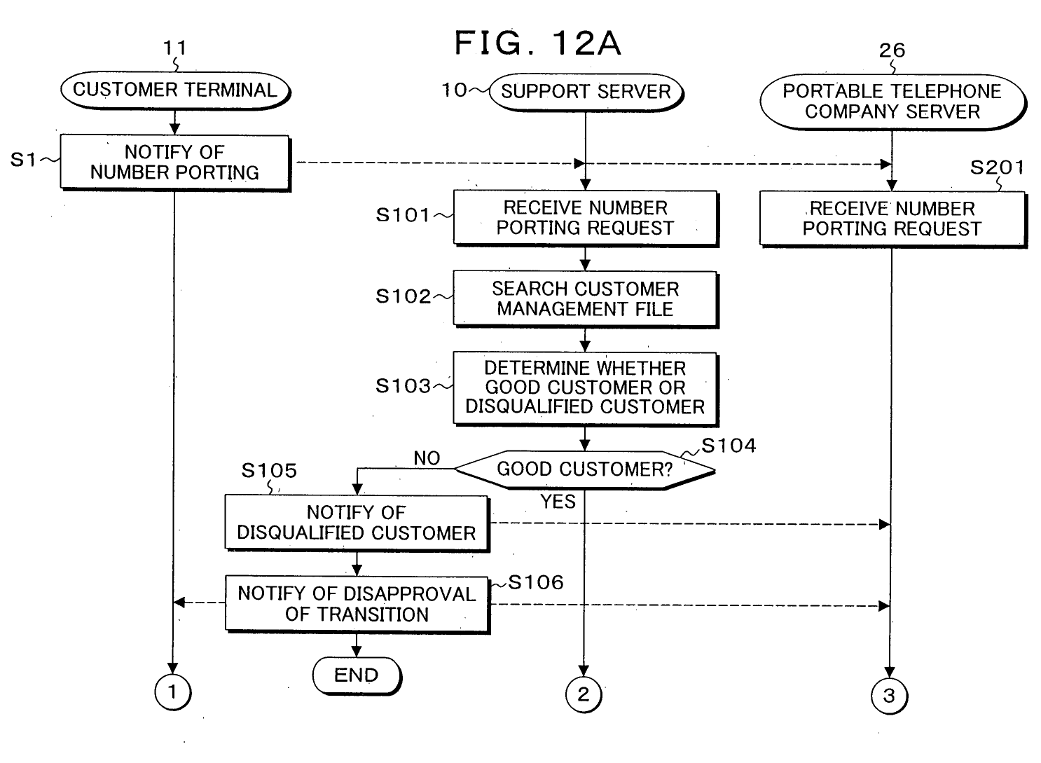

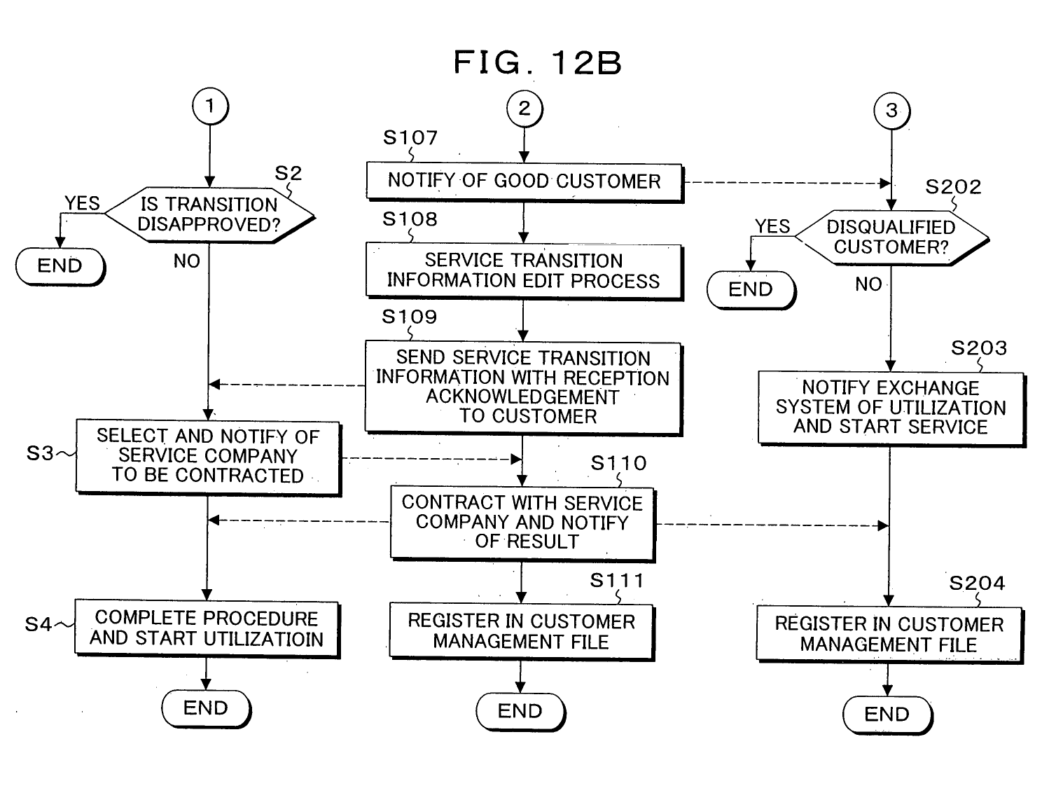

FIGS. 12A and 12B are time charts of a support process according to the present invention in an embodiment in which the support server 10 directly interacts with the customer terminal 11. More specifically, in the embodiment of FIGS. 5A and 5B, the support server performs the support process associated with transition of the number porting with the customer terminal 11 via the portable telephone company server 26, but in the embodiment of FIGS. 12A and 12B, the support server 10 is located between the customer terminal 11 and the portable telephone company server 26, such that it performs the support process associated with the number porting between both. In FIGS. 12A and 12B, when the notification of the number porting is performed from the customer terminal 11 in step S1, the number porting request is received in step S101 of the support server 10 by this, and simultaneously, the same number porting request is received in step S201 of the portable telephone company server 26. The support server 10 searches the customer management file 42 in step S102 and determines whether a good customer or a disqualified customer in step S103. If it is not a good customer in step S104, the portable telephone company server 26 is notified that it is a disqualified customer in step S105, and then, the customer terminal 11 is notified of disapproval of transition in step S106. If determined that it is a good customer in step S104, this is notified to the portable telephone company server 26 in step S107. The portable telephone company server 26 checks the notification from the support server 10 in step S202, terminates the process if it is a disqualified customer, proceeds to step S203 if it is a good customer, and notifies the exchange system of utilization to start the service. On the other hand, the support server 10 notifies that it is a good customer in step S107 and then executes the service transition information edit process in step S108. Details of this service transition information edit process are the same as the flowchart of FIG. 11. Subsequently, in step S109, a reception acknowledgement of the number porting request and the service transition information are sent to the customer terminal 11. The customer terminal 11 selects the service companies to be contracted by viewing the service transition information sent from the support server in step 3 and notifies the support server 10. In response to the notification from the customer terminal 11, the support server 10 concludes the contracts with the service companies and notifies the customer terminal 11 and the portable telephone company server 26 of the results respectively in step S110, registers the results of the contracts with the after-transition service companies in the customer management file 42 in step S112 and terminates the support process. In response to the notification of the contract results from the support server 10, the customer terminal 11 displays completion of the procedure and start of utilization in step S4, and the process is terminated. In response to the notification of the contract results from the support server 10, the portable telephone company server 26 performs registration in the company's customer management file in step S204, and the process is terminated.

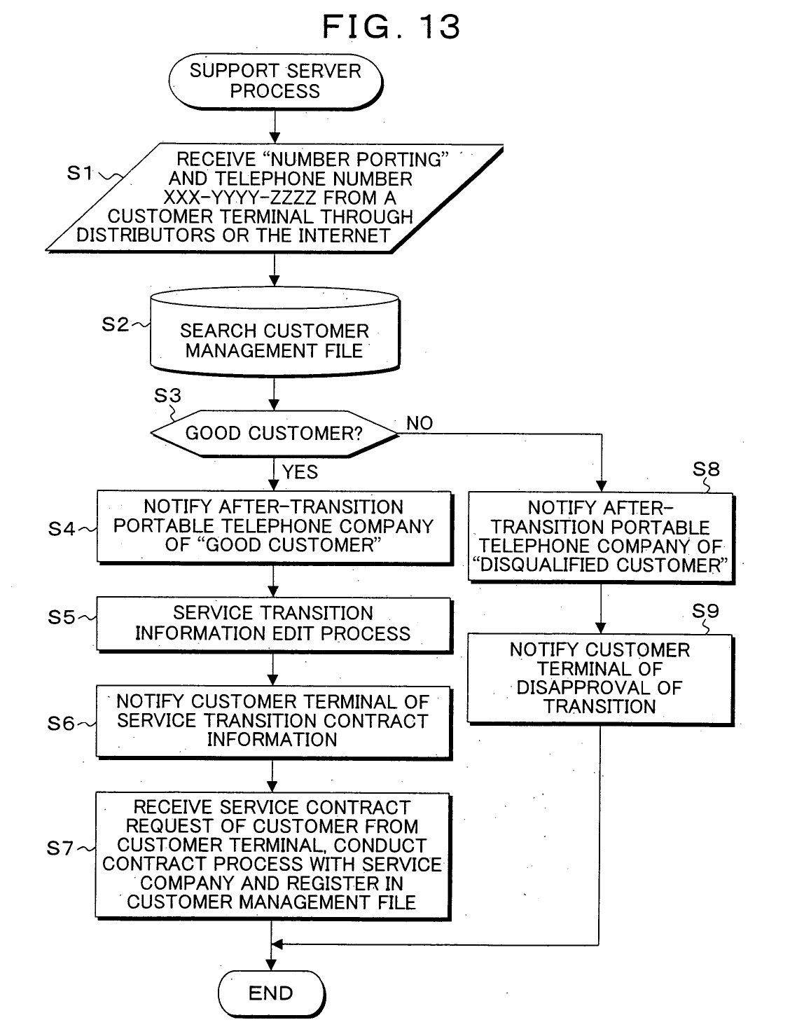

FIG. 13 is a flowchart of the support server in the embodiment of FIGS. 12A and 12B, which is as follows.

Step S1: The number porting and a telephone number are received from the customer terminal through distributors or the internet.

Step S2: The customer management file 42 is searched to obtain information of the customer who performs the number porting.

Step S3: Whether it is a good customer or not is checked from the search result of the customer management file 42. If it is a good customer, the procedure proceeds to step S4, and otherwise, the procedure proceeds to step S8.

Step S4: The after-transition portable telephone company is notified that it is a good customer.

Step S5: The service transition edit process is executed. The details are the same as FIG. 10.

Step S6: The service transition contract information is notified to the customer terminal 11.

Step S7: A service contract request is received from the customer terminal 11, and after the contracts with the service companies are concluded and the results are notified to the customer terminal 11 and the portable telephone company server 26, the registration in the customer management file 42 is performed, and the process is terminated.

Step S8: This is the case that it is not a good customer in step S3, and the after-transition portable telephone company server 26 is notified that it is a disqualified customer.

Step S9: Disapproval of transition is notified to the customer terminal 11, and the process is terminated.

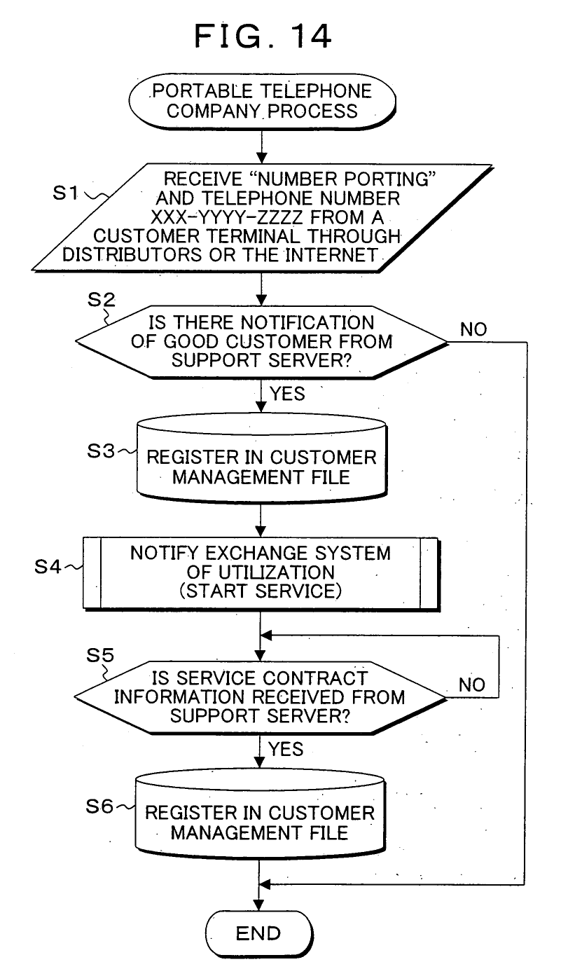

FIG. 14 is a flowchart showing the process of the portable telephone company server 26 in the embodiment of FIGS. 12A and 12B, which is as follows.

Step S1: The number porting and a telephone number are received from the customer terminal 11 through distributors or the internet.

Step S2: A notification of whether a good customer or not from the support server is checked, and if it is a good customer, the procedure proceeds to step S3, and if it is a disqualified customer, the process is terminated.

Step S3: An acceptance of the number porting is registered in the customer management file 42.

Step S4: A notification of utilization to the exchange system is performed to start the communication service.

Step S5: Whether or not the service contract information for the destination of transition is received from the support server is checked, and if it is received, the procedure proceeds to step S6, and otherwise, the procedure goes back to step S5.

Step S6: Registration in the customer management file is performed, and a series of the processes are terminated.

Although omitted in the flowcharts of FIG. 10 and FIG. 13, the support server 10 will finally send a program for performing the environment setting of the contracted services to the portable telephone terminal of the customer, based on the conclusion of the contracts with the after-transition service companies.

It is to be appreciated that the invention includes any alterations without impairing the object and advantages thereof and that the invention is not limited by the numerical values shown in the above embodiments.

1. A support method for transition between portable telephone companies using a computer, comprising:
a transition request reception step which receives a request for transition between portable telephone companies from a customer terminal;
a determination step which determines whether a customer is qualified or not;
an after-transition service information presentation step which, if it is determined that the customer is qualified, presents information about an after-transition service equivalent to a service contracted before transition and about the contract to the customer terminal; and
a service contract step which receives contract information for the after-transition service from the customer terminal to conclude the contract, the service contract step notifying the customer terminal of the result.

2. The support method for transition between portable telephone companies according to claim 1, wherein the service contract step includes, after conclusion of the contract, sending a program for performing environment setting of the contracted services to a portable telephone terminal of the customer.

3. The support method for transition between portable telephone companies according to claim 1, wherein the determination step includes, if it is determined that the customer is qualified, notifying a computer in an after-transition portable telephone company of the result of the determination to start the service.

4. The support method for transition between portable telephone companies according to claim 1, wherein the after-transition service information presentation step includes, if a service before transition is available continuously, presenting information on a continuing contract with a service company, the after-transition service information presentation step including, if the service before transition is unavailable continuously, presenting information on a new contract with another service company equivalent thereto.

5. The support method for transition between portable telephone companies according to claim 1, wherein interactions with the customer terminal in the transition request reception step, the determination step, the after-transition service information presentation step and the service contract step are performed via a computer of a portable telephone company which is the destination of transition.

6. A program operable to cause a computer supporting transition between portable telephone companies to execute:
a transition request reception step which receives a request for transition between the portable telephone companies from a customer terminal;
a determination step which determines whether a customer is qualified or not;
an after-transition service information presentation step which, if it is determined that the customer is qualified, presents information about an after-transition service equivalent to a service contracted before transition and about the contract to the customer terminal; and
a service contract step which receives contract information for the after-transition service from the customer terminal to conclude the contract, the service contract step notifying the customer terminal of the result.

7. The program according to claim 6, wherein the service contract step includes, after conclusion of the contract, sending a program for performing environment setting of the contracted services to a portable telephone terminal of the customer.

8. The program according to claim 6, wherein the determination step includes, if it is determined that the customer is qualified, notifying a computer in an after-transition portable telephone company of the result of the determination to start the service.

9. The program according to claim 6, wherein the after-transition service information presentation step includes, if a service before transition is available continuously, presenting information on a continuing contract with a service company, the after-transition service information presentation step including, if the service before transition is unavailable continuously, presenting information on a new contract with another service company equivalent thereto.

10. The program according to claim 6, wherein interactions with the customer terminal in the transition request reception step, the determination step, the after-transition service information presentation step and the service contract step are performed via a computer of a portable telephone company which is the destination of transition.

11. A support apparatus for transition between portable telephone companies using a computer, comprising:
a transition request reception unit which receives a request for transition between portable telephone companies from a customer terminal;
a determination unit which determines whether a customer is qualified or not;
an after-transition service information presentation unit which, if it is determined that the customer is qualified, presents information about an after-transition service equivalent to a service contracted before transition and about the contract to the customer terminal; and
a service contract unit which receives contract information for the after-transition service from the customer terminal to conclude the contract, the service contract unit notifying the customer terminal of the result.

12. The support apparatus according to claim 11, wherein after conclusion of the contract, the service contract unit sends a program for performing environment setting of the contracted services to a portable telephone terminal of the customer.

13. The support apparatus according to claim 11, wherein if it is determined that the customer is qualified, the determination unit notifies a computer in an after-transition portable telephone company of the result of the determination to start the service.

14. The support apparatus according to claim 11, wherein the after-transition service information presentation unit presents information on a continuing contract with a service company if a service before transition is available continuously, and wherein the after-transition service information presentation unit presents information on a new contract with another service company equivalent thereto if the service before transition is unavailable continuously.

15. The support apparatus according to claim 11, wherein interactions with the customer terminal in the transition request reception unit, the determination unit, the after-transition service information presentation unit and the service contract unit are performed via a computer of a portable telephone company which is the destination of transition.
